(19) United States
(12) Patent Application Publication
(10) Pub. No.: US 2022/0384171 A1
(43) Pub. Date: Dec. 1, 2022

(54) ION SOURCE

(71) Applicant: Micromass UK Limited, Wilmslow (GB)

(72) Inventors: Steve Bajic, Sale (GB); Richard Barrington Moulds, Stockport (GB); David Gordon, Middlewich (GB)

(73) Assignee: Micromass UK Limited, Wilmslow (GB)

(21) Appl. No.: 17/772,886

(22) PCT Filed: Oct. 23, 2020
(86) PCT No.: PCT/GB2020/052675

§ 371 Date: Apr. 28, 2022

(30) Foreign Application Priority Data
Oct. 31, 2019 (GB) 1915843.5
May 6, 2020 (GB) 2006708.8

(51) Int. Cl. H01J 49/04; H01J 49/16; H05B 6/10; H05B 6/42

(52) U.S. Cl. CPC H01J 49/0468; H01J 49/165; H01J 49/0445; H05B 6/108; H05B 6/42; H05B 2206/024

(57) ABSTRACT

An atmospheric pressure ionisation (API) ion source is provided that comprises a heater configured to heat a spray of droplets. The ion source may comprise a target, where the spray of droplets is arranged to impact upon the target. An inductive heater may be configured to surround and heat at least a part of the target. Alternatively, a resistive heater may be configured within a target comprising an electrically conductive tube. Also, there may be provided an inductive heater configured to heat a flow of gas, wherein the heated flow of gas is arranged to heat the spray of droplets.

### CROSS-REFERENCE TO RELATED APPLICATION

This application claims priority from and the benefit of United Kingdom patent application No. 1915843.5 filed on 31 Oct. 2019, and United Kingdom patent application No. 2006708.8 filed on 6 May 2020. The entire content of these documents is incorporated herein by reference.

### FIELD OF THE INVENTION

The present invention relates generally to an ion source and a method of ionising a sample, and in particular to a mass and/or ion mobility spectrometer and a method of mass and/or ion mobility spectrometry.

### BACKGROUND

Atmospheric pressure ionisation (API) ion sources, such as Electrospray ionisation (“ESI”) ion sources and Impactor ion sources, are commonly used to interface liquid chromatography (LC) systems with mass spectrometry (MS) systems.

Heaters are often used in atmospheric pressure ionisation (API) ion sources. For example, a heater is typically used to heat droplets containing analyte in order to assist with ionisation of the analyte.

It is desired to provide an improved ion source.

### SUMMARY

According to an aspect, there is provided an atmospheric pressure ionisation (API) ion source comprising an inductive heater configured to heat a spray of droplets.

Various embodiments are directed to an atmospheric pressure ionisation (API) ion source comprising an inductive (or induction) heater configured to heat a spray of droplets, such as a spray of solvent droplets containing analyte. Conventional atmospheric pressure ionisation (API) ion sources use resistive heating to heat a spray of droplets. As will be described in more detail below, the Applicant has recognised that the use of inductive heating is particularly beneficial for heating a spray of droplets during ionisation.

It will be appreciated, therefore, that various embodiments provide an improved ion source.

The ion source may comprise a sprayer configured to produce the spray of droplets.

The ion source may comprise a target.

The spray of droplets may be arranged to impact upon the target.

The inductive heater may be configured to heat the target, for example so as to heat (to transfer heat to) the spray of droplets via the target.

According to an aspect, there is provided an ion source comprising:

a sprayer configured to produce a spray of droplets;

a target, wherein the spray of droplets is arranged to impact upon the target; and

a heater configured to heat the target.

The heater may comprise an inductive (induction) heater.

According to an aspect, there is provided an ion source comprising:

a sprayer configured to produce a spray of droplets;

a target, wherein the spray of droplets is arranged to impact upon the target; and

an inductive heater configured to heat the target.

The spray of droplets may be arranged to impact upon the target so as to ionise the droplets.

The heater may be configured to heat the target so as to enhance desolvation of the droplets.

The heater may be configured to heat the target to a temperature greater than (or equal to) the Leidenfrost temperature of the droplets.

The heater may be configured to heat the target to a temperature of (i)>100° C.; (ii)>150° C.; (iii)>190° C.; (iv)>200° C.; (v)>250° C.; (vi)>300° C.; (vii)>400° C.; or (viii)>500° C.

The ion source may comprise a voltage source configured to apply a voltage to the target.

The target may comprise an electrically conductive, ferrous and/or ferritic (magnetic) material.

The heater may comprise an induction coil.

The induction coil may be arranged adjacent to the target.

The induction coil may (at least partially) surround the target.

The ion source may comprise a voltage and/or current source configured to pass an AC current through the induction coil.

The ion source may be configured such that the induction coil is closer to one or more first regions of the target than it is to a second region of the target.

The ion source may be configured such that one or more first regions of the target are surrounded by the induction coil and such that a second region of the target is other than (is not) surrounded by the induction coil.

The spray of droplets may be arranged to impact upon the second region of the target.

The second region may comprise an inner region of the target, and the one or more first regions may comprise two outer regions of the target.

The second region may comprise an end region of the target, and the one or more first regions may comprise the other end region of the target.

The one or more first regions may comprise a first electrically conductive, ferrous and/or ferritic (magnetic) material, and the second region may comprise a second different material.

The target may comprise a third different material, which may be configured to connect the first material to the second material.

The second material may be more resistant to corrosion than the first material and/or the third material.

The third different material may have a higher thermal conductivity than the first material and/or the second material.

The inductive heater may be configured to heat a flow of gas, for example so as to heat (to transfer heat to) the spray of droplets via the heated flow of gas.

According to an aspect, there is provided an ion source comprising:

a sprayer configured to produce a spray of droplets; and

an inductive heater configured to heat a flow of gas, wherein the heated flow of gas is arranged to heat the droplets.

The heater may be configured such that the heated flow of gas is provided to an exit of the sprayer.

The heater may comprise a tube, and the heater may be configured to heat the flow of gas within the tube so as to produce the heated flow of gas.

The tube may be made from an electrically insulating material.

The inductive heater may comprise an electrically conductive, ferrous and/or ferritic (magnetic) material and an induction coil.

The induction coil may be arranged adjacent to the electrically conductive, ferrous and/or ferritic (magnetic) material.

The induction coil may (at least partially) surround the electrically conductive, ferrous and/or ferritic (magnetic) material.

The electrically conductive and/or ferrous material may be located within the tube.

The induction coil may be arranged adjacent to the tube.

The induction coil may surround the tube.

The ratio of a cross sectional area of the conductive, ferrous and/or ferritic (magnetic) material to a cross sectional area of the tube may be: (i)≥0.5; (ii)≥0.6; (iii)≥0.7; (iv)≥0.8; and/or (v)≥0.9.

The ratio of a length of the conductive, ferrous and/or ferritic material to a length of the tube may be: (i)≥0.5; (ii)≥0.6; (iii)≥0.7; (iv)≥0.8; and/or (v)≥0.9.

The conductive, ferrous and/or ferritic material may comprise a material formed from metallic filaments, metallic wool, a porous material, a sintered part, or another metallic material having a relatively large surface area.

The conductive, ferrous and/or ferritic (magnetic) material may comprise metallic wool.

The ion source may comprise a voltage and/or current source configured to pass an AC current through the induction coil.

The ion source may be configured such that the flow of gas contacts the induction coil before entering the tube.

The induction coil may be hollow, and the ion source may be configured such that the flow of gas passes through the induction coil before entering the tube.

The spray of droplets may comprise a spray of charged droplets.

The spray of droplets may be arranged to impact upon one or more targets so as to ionise the droplets.

The spray of droplets may comprise solvent droplets optionally containing analyte.

According to an aspect there is provided an analytical instrument such as a mass and/or ion mobility spectrometer comprising the ion source described above.

According to an aspect, there is provided a method of ionisation comprising using the ion source described above to produce ions.

According to an aspect, there is provided a method of atmospheric pressure ionisation (API), the method comprising heating a spray of droplets using inductive heating.

The method may comprise producing the spray of droplets using a sprayer.

The method may comprise impacting the spray of droplets upon a target.

The method may comprise heating the target using inductive heating, for example so as to heat (to transfer heat to) the spray of droplets via the target.

According to an aspect, there is provided a method of ionisation comprising:

producing a spray of droplets;

causing the spray of droplets to impact upon a target; and

heating the target.

Heating the target may comprise heating the target using inductive heating.

According to an aspect, there is provided a method of ionisation comprising:

producing a spray of droplets;

causing the spray of droplets to impact upon a target; and

heating the target using inductive heating.

The method may comprise causing the spray of droplets to impact upon the target so as to ionise the droplets.

The method may comprise heating the target so as to enhance desolvation of the droplets.

The method may comprise heating the target to a temperature greater than (or equal to) the Leidenfrost temperature of the droplets.

The method may comprise heating the target to a temperature of (i)>100° C.; (ii)>150° C.; (iii)>190° C.; (iv)>200° C.; (v)>250° C.; (vi)>300° C.; (vii)>400° C.; or (viii)>500° C.

The method may comprise applying a voltage to the target.

The target may comprise an electrically conductive, ferrous and/or ferritic (magnetic) material.

The method may comprise heating the target using an induction coil.

The induction coil may be arranged adjacent to the target.

The induction coil may (at least partially) surround the target.

The method may comprise passing an AC current through the induction coil.

The induction coil may be closer to one or more first regions of the target than it is to a second region of the target.

One or more first regions of the target may be surrounded by the induction coil and a second region of the target may be other than (not) surrounded by the induction coil.

The method may comprise causing the spray of droplets to impact upon the second region of the target.

The second region may comprise an inner region of the target, and the one or more first regions may comprise two outer regions of the target.

The second region may comprise an end region of the target, and the one or more first regions may comprise the other end region of the target.

The one or more first regions may comprise a first electrically conductive, ferrous and/or ferritic (magnetic) material, and the second region may comprise a second different material.

The target may comprise a third different material, which may be configured to connect the first material to the second material.

The second material may be more resistant to corrosion than the first material and/or the third material.

The third different material may have a higher thermal conductivity than the first material and/or the second material.

The method may comprise heating a flow of gas using inductive heating, for example so as to heat (to transfer heat to) the spray of droplets via the heated flow of gas.

According to an aspect, there is provided a method of ionisation comprising:

producing a spray of droplets;

heating a flow of gas using inductive heating; and

heating the spray of droplets using the heated flow of gas.

The method may comprise producing the spray of droplets using a sprayer.

The method may comprise providing the heated flow of gas to an exit of the sprayer.

The heater may comprise a tube, and the method may comprise heating the flow of gas within the tube so as to produce the heated flow of gas.

The tube may be made from an electrically insulating material.

The method may comprise heating the flow of gas using an electrically conductive, ferrous and/or ferritic (magnetic) material and an induction coil.

The induction coil may be arranged adjacent to the electrically conductive, ferrous and/or ferritic (magnetic) material.

The induction coil may (at least partially) surround the electrically conductive, ferrous and/or ferritic (magnetic) material.

The electrically conductive, ferrous and/or ferritic (magnetic) material may be located within the tube.

The induction coil may be arranged adjacent to the tube.

The induction coil may surround the tube.

The ratio of a cross sectional area of the conductive, ferrous and/or ferritic (magnetic) material to a cross sectional area of the tube may be: (i)≥0.5; (ii)≥0.6; (iii)≥0.7; (iv)≥0.8; and/or (v)≥0.9.

The ratio of a length of the conductive, ferrous and/or ferritic material to a length of the tube may be: (i)≥0.5; (ii)≥0.6; (iii)≥0.7; (iv)≥0.8; and/or (v)≥0.9.

The conductive, ferrous and/or ferritic material may comprise a material formed from metallic filaments, metallic wool, a porous material, a sintered part, or another metallic material having a relatively large surface area.

The conductive, ferrous and/or ferritic (magnetic) material may comprise metallic wool.

The method may comprise passing an AC current through the induction coil.

The method may comprise causing the flow of gas to contact the induction coil before entering the tube.

The induction coil may be hollow, and the method may comprise passing the flow of gas through the induction coil before the flow of gas enters the tube.

The spray of droplets may comprise a spray of charged or uncharged droplets.

The method may comprise causing the spray of droplets to impact upon a target so as to ionise the droplets.

The droplets may comprise solvent droplets optionally containing analyte.

According to an aspect there is provided a method of mass and/or ion mobility spectrometry comprising ionising an analyte using the method of ionisation described above.

According to an aspect, there is provided an ion source comprising:

a sprayer configured to produce a spray of droplets;

a target comprising an electrically conductive tube, wherein the spray of droplets is arranged to impact upon the electrically conductive tube;

a heater configured to heat the target, wherein the heater comprises a heating element arranged within the tube; and

a first voltage source configured to apply a first voltage V₁ to the electrically conductive tube.

The target may comprise one or more first regions and a second region. The spray of droplets may be arranged to impact upon the second region of the target. The heating element may be arranged within the second region of the target.

The second region may comprise a central region of the target.

The heater may comprise a resistive (resistance) heater.

The heater may comprise a second voltage source configured to cause a current to pass through the heating element.

The second voltage source may be configured to apply a voltage ΔV between a first end of the heating element and a second end of the heating element.

Alternatively, the first voltage source and a second voltage source may be configured to apply a voltage ΔV between the first end of the heating element and the second end of the heating element.

The first voltage source may be configured to apply the first voltage V₁ to the first end of the heating element (such that the first end of the heating element is maintained at substantially the same voltage as the electrically conductive tube), and the second voltage source may be configured to apply a second different voltage V2 to the second end of the heating element, where |V₂−V₁|=ΔV.

The spray of droplets may be arranged to impact upon the target so as to ionise the droplets.

The heater may be configured to heat the target so as to enhance desolvation of the droplets.

The heater may be configured to heat the target, for example so as to heat (to transfer heat to) the spray of droplets via the target.

The heater may be configured to heat the target to a temperature greater than (or equal to) the Leidenfrost temperature of the droplets.

The heater may be configured to heat the target to a temperature of (i)>100° C.; (ii)>150° C.; (iii)>190° C.; (iv)>200° C.; (v)>250° C.; (vi)>300° C.; (vii)>400° C.; or (viii)>500° C.

The spray of droplets may comprise solvent droplets optionally containing analyte.

According to an aspect there is provided an analytical instrument such as a mass and/or ion mobility spectrometer comprising the ion source described above.

According to an aspect, there is provided a method of ionisation comprising using the ion source described above to produce ions.

According to an aspect, there is provided a method of ionisation comprising:

producing a spray of droplets;

causing the spray of droplets to impact upon a target comprising an electrically conductive tube;

heating the electrically conductive tube using a heating element arranged within the tube; and

applying a first voltage V₁ to the electrically conductive tube.

The target may comprise one or more first regions and a second region.

The method may comprise causing the spray of droplets to impact upon the second region of the target.

The heating element may be arranged within the second region of the target.

The second region may comprise a central region of the target.

The method may comprise causing a current to pass through the heating element.

The method may comprise applying a voltage ΔV between a first end of the heating element and a second end of the heating element.

The method may comprise maintaining a first end of the heating element at substantially the same voltage as the electrically conductive tube.

The method may comprise heating the target using resistive (resistance) heating, for example so as to heat (to transfer heat to) the spray of droplets via the target.

The method may comprise causing the spray of droplets to impact upon the target so as to ionise the droplets.

The method may comprise heating the target so as to enhance desolvation of the droplets.

The method may comprise heating the target to a temperature greater than (or equal to) the Leidenfrost temperature of the droplets.

The method may comprise heating the target to a temperature of (i)>100° C.; (ii)>150° C.; (iii)>190° C.; (iv)>200° C.; (v)>250° C.; (vi)>300° C.; (vii)>400° C.; or (viii)>500° C.

The droplets may comprise solvent droplets optionally containing analyte.

According to an aspect there is provided a method of mass and/or ion mobility spectrometry comprising ionising an analyte using the method of ionisation described above.

### BRIEF DESCRIPTION OF THE DRAWINGS

Various embodiments will now be described, by way of example only, and with reference to the accompanying drawings in which:

FIG. 1 shows a typical relationship between droplet velocity and Leidenfrost temperature (T_{L}) for water droplets on a polished aluminium surface;

FIG. 2 shows schematically an ion source in accordance with various embodiments;

FIG. 3A shows schematically a top-down view of an ion source in accordance with various embodiments, and FIG. 3B shows schematically a side view of an ion source in accordance with various embodiments;

FIG. 4 is a photograph of an ion source constructed in accordance with various embodiments;

FIG. 5A shows a mass spectrum obtained using an ion source operated in accordance with various embodiments, and FIG. 5B shows a mass spectrum obtained using an ion source without inductive heating;

FIG. 6A shows a mass spectrum obtained using an ion source without inductive heating, and FIG. 6B shows a mass spectrum obtained using an ion source operated in accordance with various embodiments;

FIG. 7A shows a mass spectrum obtained using an ion source operated in accordance with various embodiments, and FIG. 7B shows a mass spectrum obtained using an ion source without inductive heating;

FIG. 8A shows a mass spectrum obtained using an ion source operated in accordance with various embodiments, and FIG. 8B shows a mass spectrum obtained using an ion source without inductive heating;

FIG. 9 shows relative signal intensity data obtained (a) using an ion source operated in accordance with various embodiments and (b) using an ion source without inductive heating;

FIG. 10A shows schematically an impactor target in accordance with various embodiments, and FIG. 10B shows schematically an impactor target in accordance with various embodiments;

FIG. 11 is a photograph of an ion source constructed in accordance with various embodiments;

FIG. 12 shows schematically an impactor target in accordance with various embodiments;

FIG. 13 shows schematically an impactor target in accordance with various embodiments;

FIG. 14 shows schematically an impactor target in accordance with various embodiments;

FIG. 15 shows schematically a heater in accordance with various embodiments;

FIG. 16 shows schematically an ion source in accordance with various embodiments;

FIG. 17 shows schematically an ion source in accordance with various embodiments; and

FIG. 18 shows schematically an analytical instrument in accordance with various embodiments.

### DETAILED DESCRIPTION

Various embodiments are directed to an ion source such, as an atmospheric pressure ionisation (API) ion source, which may be for or may form part of an analytical instrument such as a mass and/or ion mobility spectrometer. The atmospheric pressure ionisation (API) ion source may convert the liquid flow from a liquid chromatography (LC) column or sample reservoir into a nebulised spray of fine droplets. The droplets may have diameters, for example, in the range 0.1-100 μm.

In the case of electrospray ionisation (ESI), the droplets are charged and the process of producing gas-phase ions for (MS) analysis involves the evaporation (shrinking) of charged droplets to a point where the electrostatic force exceeds the force due to surface tension. Under these conditions, the charged droplets disintegrate and can liberate gas-phase ions for analysis. The spray of droplets may be surrounded with a flow of heated gas that transfers heat to the droplets to aid evaporation.

In a conventional heater design, a resistively-heated element is surrounded by a metallic shroud that acts as a conduit for the gas flow. Cold gas enters the shroud, passes over the hot surface of the heater element and then exits the shroud at some distance from the tip of the sprayer. Since the sprayer is typically held at a high voltage (HV) for ESI operation, the outlet of the heater must be located at a reasonable distance (>5-10 mm) from the sprayer.

This conventional heating arrangement is generally inefficient due to limited heat transfer at the element surface, rapid cooling of the gas as it expands at the outlet, and considerable heat losses from the shroud due to conduction and radiation. In practice, it has been found that heater element temperatures in excess of 600° C. are required to produce a gas temperature of approximately 300° C. at a centimetre or so from the outlet, where the gas temperature is then further reduced when the unheated nebuliser gas and liquid flow are applied. Under these inefficient conditions, high power densities at the element can reduce the lifetime of the heater assembly.

These problems may be addressed, in accordance with various embodiments, by making the shroud from a non-conductive material and by tightly packing the gas flow volume with a ferrous and/or ferritic (magnetic) material, such as wire wool, that does not overly impede the flow of gas through the shroud. The non-conductive shroud can then be surrounded by (or arranged adjacent to) an induction coil that selectively transfers power to the wire wool and not the shroud material. Here, ferromagnetic materials like iron may be efficiently heated by a combination of Joule heating and magnetic hysteresis losses due to the high frequency magnetic field that is generated from the coil.

In this system, the heating efficiency is increased due to increased heat transfer at the high surface area of the wire wool, the extension of the heating zone to the exit of the shroud, and greatly reduced conductive and radiative losses from the insulating shroud. Furthermore, the non-conductive shroud can be closely coupled to the ESI tip without fear of electrical discharge.

An impactor spray ionisation source may use the same sprayer/heater arrangement as described above, but the (uncharged) spray is typically directed to impact onto a target such as a high voltage (HV) cylindrical target (impactor) that may be placed between the grounded sprayer and the inlet of the analytical instrument (MS). The impactor may be mounted on an insulating support and may be indirectly heated by the flow of hot gas from the heater shroud. The role of the impactor is to break-up primary, high velocity droplets into smaller secondary droplets, where the process is highly dependent on the surface temperature of the impactor.

When a sessile liquid droplet comes into contact with a surface that is significantly hotter than the boiling point of the liquid, a vapour layer is formed between the droplet and the surface which reduces the rate of heat transfer and consequently slows down the evaporation rate of the droplet. This process is known as the Leidenfrost effect and is very dependent on the surface material, surface finish and the size of the droplets. Depending on the experimental conditions, water may have a Leidenfrost temperature (T_{L}) of around 190° C. For an impactor surface temperature of <190° C., high velocity water droplets will directly contact the surface and start to spread outwards in a thin layer until the surface roughness causes instability in the layer and subsequent break up into secondary droplets. For an impactor temperature of >190° C., water droplets will spread outwards on a “cushion” of water vapour and will not come into direct contact with the surface. Here, early break-up due to contact with the surface is avoided, and a thinner layer is produced which eventually breaks up into even smaller droplets due to vapour pressure forces. The production of smaller secondary droplets increases the rate of evaporation and increases the probability of producing gas phase ions for (MS) analysis.

In order to maintain the surface of the impactor at a temperature greater than T_{L}, the cooling effects from the cold nebuliser gas and liquid droplet bombardment need to be counteracted.

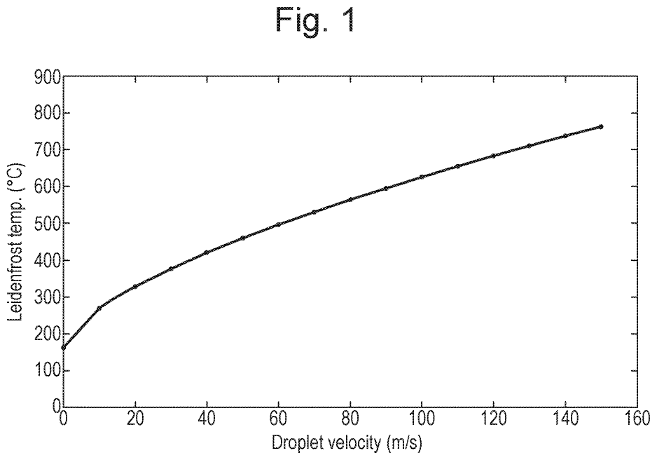

In fact, the above Leidenfrost model for sessile droplets is simplified since it does not consider the fact that T_{L} increases with increasing droplet impact velocity which consequently requires even higher surface temperatures to prevent liquid contact with the surface. This is illustrated by FIG. 1, which shows a typical relationship between droplet velocity and Leidenfrost temperature (T_{L}) over a velocity range that is valid for impactor spray ion sources. The data is shown for water droplets impacting on a polished aluminium surface (from Bernardin, J. D. and Mudawar, I., Journal of Heat Transfer (2004), 126, 272-278).

In accordance with various embodiments, higher surface temperatures can be accomplished in an impactor spray source by directly heating the impactor target. Conventional resistive heating is not ideal since conducting heat from a heater block to a cylindrical target that is typically 1.6 mm in diameter is extremely inefficient, and furthermore, the heating circuit must be decoupled from the high voltage that is applied to the impactor.

These problems can be addressed, in accordance with various embodiments, by using a ferrous and/or ferritic (magnetic) (or part ferrous and/or ferritic) impactor that is surrounded by (or adjacent to) an induction coil that efficiently heats the impactor but is physically decoupled from it, thus enabling the application of a high voltage.

It will accordingly be appreciated that various embodiments are directed to an ion source comprising an inductive heater (an induction heater) configured to (indirectly) heat a spray of droplets.

In various particular embodiments, the ion source comprises an atmospheric pressure ionisation (API) ion source such as an electrospray ionisation (ESI) ion source or an impactor ion source.

However, more generally, the ion source 10 may comprise any suitable ion source such as an ion source selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“Cl”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; (xvi) a Nickel-63 radioactive ion source; (xvii) an Atmospheric Pressure Matrix Assisted Laser Desorption Ionisation ion source; (xviii) a Thermospray ion source; (xix) an Atmospheric Sampling Glow Discharge Ionisation (“ASGDI”) ion source; (xx) a Glow Discharge (“GD”) ion source; (xxi) an Impactor ion source; (xxii) a Direct Analysis in Real Time (“DART”) ion source; (xxiii) a Laserspray Ionisation (“LSI”) ion source; (xxiv) a Sonicspray Ionisation (“SSI”) ion source; (xxv) a Matrix Assisted Inlet Ionisation (“MAII”) ion source; (xxvi) a Solvent Assisted Inlet Ionisation (“SAII”) ion source; (xxvii) a Desorption Electrospray Ionisation (“DESI”) ion source; (xxviii) a Laser Ablation Electrospray Ionisation (“LAESI”) ion source; (xxix) a Surface Assisted Laser Desorption Ionisation (“SALDI”) ion source; (xxx) a Low Temperature Plasma (“LTP”) ion source; (xxxi) a Helium Plasma Ionisation (“HePI”) ion source; (xxxii) a Rapid Evaporative Ionisation Mass Spectrometry (“REIMS”) ion source; and (xxxiii) a Laser Assisted Rapid Evaporative Ionisation Mass Spectrometry (“LA-REIMS”) ion source.

The ion source may comprise a sprayer, such as a nebuliser, configured to produce a spray of droplets. The sprayer may have any suitable form. The sprayer should have at least one droplet outlet which emits, in use, the spray or stream of droplets.

In various embodiments, the sprayer (nebuliser) comprises a first capillary tube and a second capillary tube, for example where the second capillary tube at least partially surrounds the first capillary tube (in a concentric manner or otherwise). A liquid (solvent) may be passed through the first capillary tube and a (nebuliser) gas may be passed through the second capillary tube. The (liquid) outlet of the first capillary tube and the (gas) outlet of the second capillary tube may be configured so that the gas (that is, a stream of gas) is provided to the outlet of the first capillary tube.

The arrangement of the capillaries, the flow rate of the liquid and/or the flow rate of the gas may be configured such that a spray of droplets is produced by the sprayer.

The first capillary tube may have an internal diameter of around (i)<100 μm; (ii) 100-120 μm; (iii) 120-140 μm; (iv) 140-160 μm; (v) 160-180 μm; (vi) 180-200 μm; or (vii)>200 μm. The first capillary tube may have an outer diameter of around (i)<180 μm; (ii) 180-200 μm; (iii) 200-220 μm; (iv) 220-240 μm; (v) 240-260 μm; (vi) 260-280 μm; (vii) 280-300 μm; or (viii)>300 μm. The second capillary tube may have an internal diameter of around (i)<280 μm; (ii) 280-300 μm; (iii) 300-320 μm; (iv) 320-340 μm; (v) 340-360 μm; (vi) 360-380 μm; (vii) 380-400 μm; or (viii)>400 μm.

The sprayer may receive a flow of liquid such as a flow of solvent (optionally containing analyte) and may be configured to produce the spray of droplets from the flow of liquid. The liquid may be provided to the sprayer with a flow rate of, for example, (i) 100 μL/min; (ii) 200 μL/min; (iii) 300 μL/min; (iv) 400 μL/min; or (v) 500 μL/min.

The flow of liquid may be, for example, an eluent from a liquid chromatography system. Thus, the ion source may be coupled to a liquid chromatography or other separation device. Alternatively, the flow of liquid may be from a (sample) reservoir.

The spray of droplets may comprise a spray of solvent droplets, optionally containing analyte (analyte molecules). The droplets may comprise (i) water; (ii) formic acid and/or another organic acid; (iii) acetonitrile; and/or (iv) methanol. Other possible solvents include ethanol, propanol and isopropanol. The solvent may comprise any suitable non-acidic or acidic additives such as acetic acid, ammonium hydroxide, ammonium formate, ammonium acetate, etc. Other solvents and/or additives would be possible.

In various embodiments, a gas may be provided to the sprayer, for example to the second capillary tube, with a flow rate of (i)<100 L/hr; (ii) 100-150 L/hr; (iii) 150-200 L/hr; (iv) 200-250 L/hr; (v) 250-300 L/hr; (vi) 300-350 L/hr; (vii) 350-400 L/hr; or (viii)>400 L/hr. The gas may comprise any suitable nebulising gas such as for example nitrogen.

The spray of droplets may be charged and/or nominally un-charged (nominally electrically neutral).

The ion source may comprise a voltage source configured to apply a voltage, such as a high voltage (HV), to the (first and/or second capillary of the) sprayer. Any suitable voltage may be applied to the sprayer, such as a voltage of (i)<500 V; (ii) 500 V-1 kV; (iii) 1-2 kV; (iv) 2-3 kV; (v) 3-4 kV; (vi) 4-5 kV; or (vii)>5 kV. The voltage may be positive or negative. Alternatively, the (first and/or second capillary of the) sprayer may be grounded. The first and second capillaries of the sprayer may be maintained at the same (or different) potential(s).

The ion source comprises an inductive heater configured to heat the spray of droplets. The heating may be done as part of the ionisation process, for example so as to evaporate, shrink, desolvate and/or break up the droplets.

The inductive heater may be configured to indirectly heat the spray of droplets. For example, the inductive heater may be configured to (directly) heat an impactor target of the ion source, where the ion source may be configured such that the heated target heats (at least part of) the spray of droplets, and/or to (directly) heat a flow of gas (such as a nebuliser gas), where the ion source may be configured such that the heated flow of gas heats (at least part of) the spray of droplets.

In various particular embodiments, the ion source comprises an impactor ion source. Thus, the ion source may comprise a target, and the spray of droplets may be arranged to impact upon the target, for example so as to ionise the droplets. In these embodiments, a heater such as an inductive heater or a resistive heater may be configured to heat the target. This may be so as to heat the spray of droplets via the target.

In these embodiments, the target may not transfer much heat to the droplets, but may serve to create smaller droplets, which in turn, may lead to enhance droplet desolvation (as described above).

Thus, the (inductive) heater may be configured to heat the target so as to enhance desolvation of the droplets. The (inductive) heater may be configured to heat the target to a temperature greater than (or equal to) the Leidenfrost temperature of the droplets. The (inductive) heater may be configured to heat the target to a temperature of (i)>100° C.; (ii)>150° C.; (iii)>190° C.; (iv)>200° C.; (v)>250° C.; (vi)>300° C.; (vii)>400° C.; or (viii)>500° C.

The target may comprise any suitable target and may have any suitable form. The target may comprise, for example, a rod, a pin, a needle shaped target, a cone shaped target, a grid or a mesh target. The target may comprise a tube such as a cylindrical target. The target may have a size (e.g. diameter), for example, of: (i)<1 mm; (ii) 1 to 1.5 mm; (iii) 1.5 to 2 mm; (iv) 2 to 3 mm; (v) 3 to 4 mm; (vi) 4 to 5 mm; or (vii)>5 mm. The target may be formed from any suitable material, such as glass, stainless steel, metal, gold, a non-metallic substance, a semiconductor, a metal or other substance with a carbide coating, a metal with an oxide coating, an insulator or a ceramic, etc.

In various particular embodiments, the target is formed from an electrically conductive material.

The target should be located downstream of the outlet(s) of the sprayer (nebuliser), so that at least some of the droplets emitted from the sprayer impact upon the surface of the target.

The target may be located at any suitable distance from the (droplet) outlet of the sprayer. According to various embodiments, the target is located a distance from the (droplet) outlet of the sprayer of: (i)<20 mm; (ii)<19 mm; (iii)<18 mm; (iv)<17 mm; (v)<16 mm; (vi)<15 mm; (vii)<14 mm; (viii)<13 mm; (ix)<12 mm; (x)<11 mm; (xi)<10 mm; (xii)<9 mm; (xiii)<8 mm; (xiv)<7 mm; (xv)<6 mm; (xvi)<5 mm; (xvii)<4 mm; (xviii)<3 mm; or (xix)<2 mm.

In various embodiments, a voltage is applied to the target. This can increase the ionization efficiency. As such, the ion source may comprise a voltage source that is configured to apply a voltage to the target. Any suitable voltage may be applied to the target. According to various embodiments, a voltage of (i)<200 V; (ii) 200-400 V; (iii) 400-600 V; (iv) 600-800 V; (v) 800 V-1 kV; (vi) 1-2 kV; (vii) 2-3 kV; (viii) 3-4 kV; (ix) 4-5 kV; or (x)>5 kV is applied to the target. The voltage may be positive or negative. Alternatively, the target may be grounded.

According to various particular embodiments, droplets are emitted from a (for example grounded or charged) sprayer and are caused to impact upon one or more impactor targets that may be grounded or held at a high voltage. The target may have the effect of enhancing droplet break up and ion formation from the droplets produced by the sprayer.

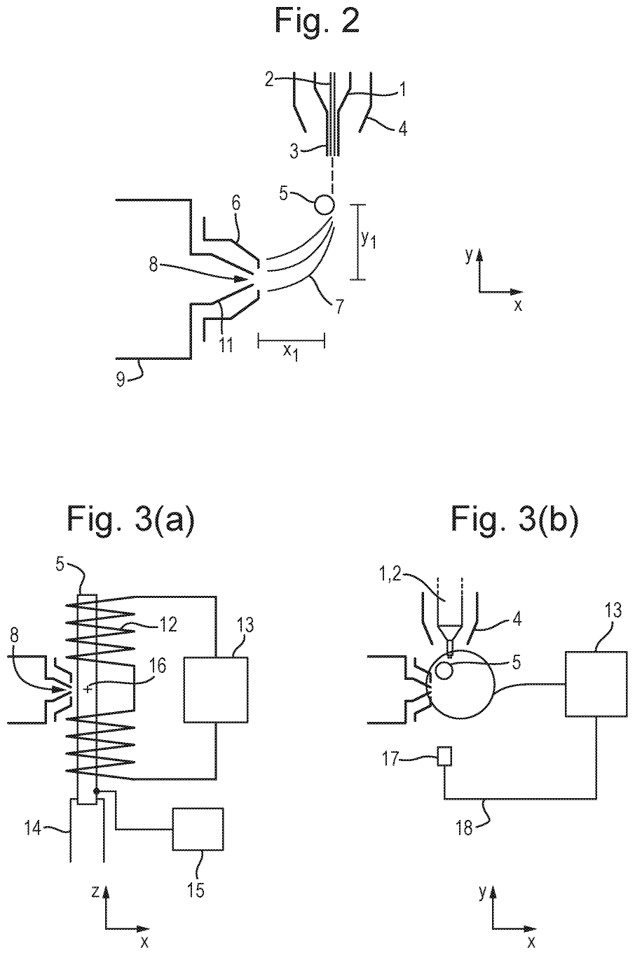

An impactor spray ion source is shown schematically in FIG. 2. This comprises a pneumatic nebulizer assembly 1, a desolvation heater 4, an impactor target 5 and an analytical instrument (MS) inlet assembly. This arrangement may be surrounded by an electrically grounded source enclosure that contains an exhaust outlet for the venting of solvent fumes (not shown in FIG. 2).

The nebuliser assembly 1 may be composed of an inner liquid capillary 2 and an outer gas capillary 3 which may deliver a high velocity stream of gas at the nebulizer tip to aid the atomization of the liquid solvent flow. The liquid capillary 2 may have an internal diameter of around 130 μm and an external diameter of around 270 μm, whilst the gas capillary may have an internal diameter of around 330 μm. The gas supply (such as nitrogen) may be pressurized to approximately 7 bar and a liquid flow rate of 0.1 to 1 mL/min may be used.

A heated desolvation gas (nitrogen) may flow between the nebulizer 1 and the heater 4 at a flow rate of around 1200 L/hr. The high velocity stream of droplets from the nebulizer 1 may impact on a 1.6 mm diameter stainless steel, cylindrical rod target 5. The nebulizer 1 and impactor target 5 may be held at 0 V and 1 kV, respectively, whilst the MS inlet may be close to ground potential (0-100 V).

A nitrogen curtain (cone) gas flow of around 150 L/hr may pass between the cone gas nozzle 6 and the ion inlet cone 11. Ions, charged particles, or neutrals that are contained within the gas flow wake 7 from the impactor target 5 can enter the analytical instrument (mass spectrometer) via the ion inlet orifice 8 which may form a boundary between the first vacuum region 9 of the instrument and the atmospheric pressure region of the source enclosure.

When the diameter of the impactor target 5 is significantly greater than the internal diameter of the liquid capillary 2, it is beneficial to direct the spray such that it impacts the target 5 on the upper right-hand quadrant, as shown in FIG. 2. Under these conditions, the gas flow wake 7 follows the curvature of the target (Coanda effect) and is swung in the direction of the ion inlet orifice 8 which results in a greater ion signal intensity.

As shown in FIG. 2, the target 5 may be located at a first distance x₁ in a first (x) direction from the ion inlet orifice 8 and at a second distance y₁ in a second (y) direction from the ion inlet orifice 8, wherein the second (y) direction is orthogonal to the first (x) direction.

The first (x) direction may be a central axis of the cone gas nozzle 6 and the ion inlet cone 11. That is, the cone gas nozzle 6, the ion inlet cone 11, and the ion inlet orifice 8 may be arranged coaxially with respect to the first (x) direction. x₁ may be selected from the group consisting of: (i) 0-1 mm; (ii) 1-2 mm; (iii) 2-3 mm; (iv) 3-4 mm; (v) 4-5 mm; (vi) 5-6 mm; (vii) 6-7 mm; (viii) 7-8 mm; (ix) 8-9 mm; (x) 9-10 mm; and (xi)>10 mm.

The second (y) direction may be a central axis of the nebuliser assembly 1, the inner liquid capillary 2 and the outer gas capillary 3. That is, the nebuliser assembly 1, the inner liquid capillary 2 and the outer gas capillary 3 may be arranged coaxially with respect to the second (y) direction. y₁ may be selected from the group consisting of: (i) 0-1 mm; (ii) 1-2 mm; (iii) 2-3 mm; (iv) 3-4 mm; (v) 4-5 mm; (vi) 5-6 mm; (vii) 6-7 mm; (viii) 7-8 mm; (ix) 8-9 mm; (x) 9-10 mm; and (xi)>10 mm.

The intention of various embodiments is to provide additional heating to the impactor target 5 to compensate for localised cooling that occurs at the spray impact point due to the action of an unheated nebuliser gas and impacting liquid droplets.

Induction heating is a highly efficient method of providing localised heating and benefits from the fact that the object to be heated is not in physical contact with the heater power supply. This is particularly beneficial in an impactor spray source, where it is desirable to raise the potential of the impactor to one or more kilovolts with respect to the MS inlet.

In induction heating, the object of interest may be surrounded by (or arranged adjacent to) an induction coil which may be driven by a high frequency (5-500 kHz) alternating voltage. The rapidly alternating magnetic field from the coil penetrates the object and produces heat by both Joule heating and magnetic hysteresis losses. The former is proportional to the resistivity of the object and the latter is proportional to its magnetic permeability.

FIG. 3 is a schematic diagram of an impactor spray source that incorporates an inductively heated impactor, in accordance with various embodiments.

The plan view of FIG. 3(a) shows how the impactor 5 may be surrounded by an induction coil 12 that is connected to an AC power supply 13. The impactor 5 may be held in position by a glass insulator 14 and may be biased by a HV power supply 15. The nebuliser and desolvation heater assemblies have been omitted from FIG. 3(a) for clarity.

Thus, in accordance with various embodiments, the target may comprise an electrically conductive, ferrous and/or ferritic (magnetic) material (such as mild steel), and the heater may comprise an induction coil that may (at least partially) surround the target. The ion source may also comprise a voltage and/or current source configured to pass an AC current through the induction coil.

A gap in the coil winding may be deliberately engineered to provide access for the inlet 8 and nebulizer such that the spray is unimpeded and strikes the spray impact point 16, marked as a cross, on the impactor 5.

Thus, the ion source may be configured such that one or more first regions of the target are surrounded by the induction coil and such that a second region of the target is other than (is not) surrounded by the induction coil, where the spray of droplets may be arranged to impact upon the second region of the target.

As shown in FIG. 3(a), the target 5 may have a longitudinal axis, which may extend in a third (z) direction. The third (z) direction may be orthogonal to the first (x) and second (y) directions.

As shown in FIG. 3(a), the second region may comprise an inner region of the target (that is, a central region of the target in the third (z) direction), and the one or more first regions may comprise two outer regions of the target (that is, two regions at either end of the target in the third (z) direction). Thus, the induction coil may comprise a gap, and the outer regions of the target (rod) may be surrounded by the induction coil, but the inner region of the target (rod) may be aligned with the gap in the induction coil.

The side view of FIG. 3(b) shows the position of the nebulizer 1, 2 and the desolvation gas heater 4. Additionally, an infrared or other temperature sensor 17 can be included, for example in combination with a feedback loop 18, to regulate the AC power supply 13 and maintain the impactor at a constant temperature.

According to various other embodiments, the induction coil 12 may be arranged adjacent to the impactor 5, that is, without necessarily surrounding the impactor 5. In these embodiments, the impactor 5 may be arranged outside the induction coil 12, and in close proximity with the induction coil, for example sufficiently close to the induction coil that the magnetic field strength from the induction coil 12 is sufficiently high to cause inductive heating in the impactor 5 (as described above). In these (and other) embodiments, the induction coil 12 need not have a gap.

In these (and other) embodiments, the ion source may be configured such that the induction coil is closer to one or more first regions of the target than it is to a second region of the target, where the spray of droplets may be arranged to impact upon the second region of the target. For example, the induction coil may have a gap aligned with the second (inner) region of the target (as described above).

Alternatively, the induction coil may be arranged adjacent a first side of the target (for example, in the first (x) and/or second (y) direction), and the spray of droplets may be arranged to impact upon a second different (for example, opposite) side of the target.

It would also be possible for the ion source to be configured such that the induction coil is arranged in similar proximity to the one or more first regions and the second (impact) region of the target. For example, the induction coil may be arranged adjacent a particular side of the target, and the spray of droplets may be arranged to impact upon the same side of the target.

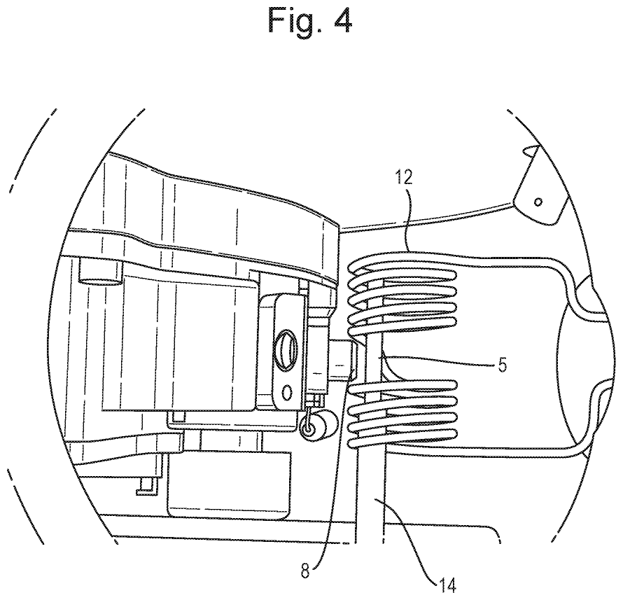

FIG. 4 is a photograph of an impactor spray source that was constructed according to the embodiment shown in FIG. 3. The photograph was taken through the access port that accommodates the nebulizer and desolvation heater assemblies in normal operation. The impactor was made from 2.5 mm diameter mild steel (carbon steel) and was chosen for its high relative magnetic permeability (˜100), and hence its propensity to heat in a high frequency magnetic field. The induction coil (15 mm diameter) was constructed from 2 mm diameter tinned copper wire and was driven by a 5-12 V, 200 kHz AC power supply.

FIG. 4 shows that for total inductive power consumption of 25 W, the mild steel impactor glows red-hot (>500° C.) in the absence of a nebuliser gas flow and liquid flow. Under typical impactor spray conditions, that is with an unheated nebuliser gas flow of 120 L/hr, a desolvation gas flow of 1200 L/hr (300° C.) and a liquid flow rate of 0.2-1.0 mL/min, it is believed that the spray impact point region cools to an extent that the red glow is no longer clearly visible.

A series of experiments were conducted to investigate the effects of directly heating the impactor target on impactor spray source performance. In all experiments, the analyte of interest was constantly infused into the source at a known solution concentration. It should be appreciated that these experiments are similar to an LC/MS experiment where the latter differs in that the analyte only enters the source for a short period (typically <2 seconds) after a period of retention on the LC column.

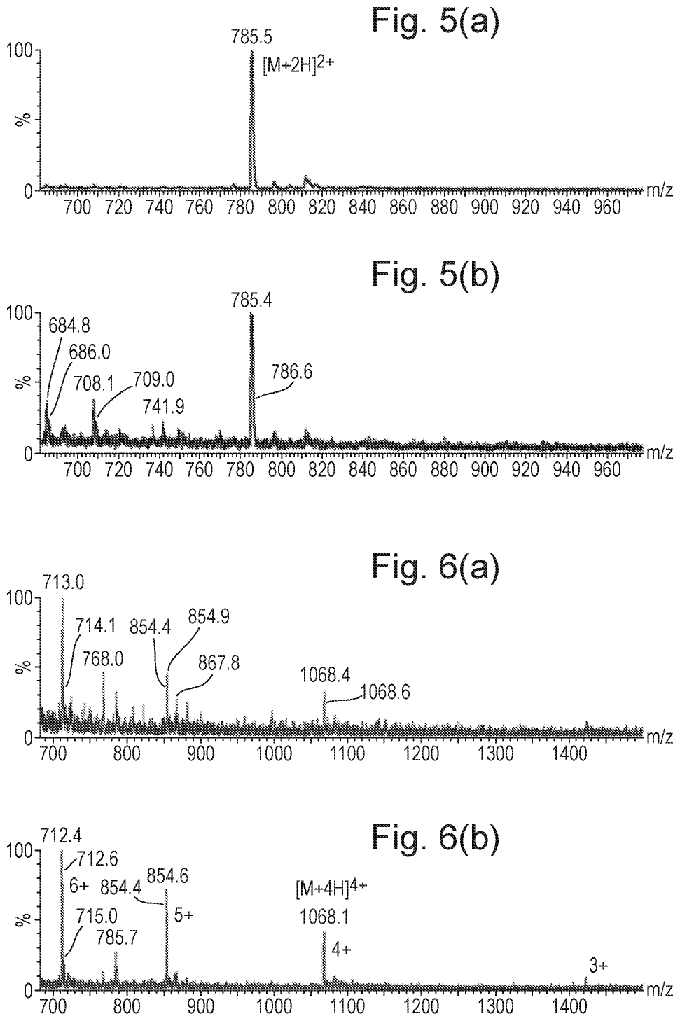

FIG. 5 shows the data obtained for the analysis of Glu-fibrinopeptide (Glu-fib) with and without inductive heating of the mild steel impactor (shown in FIG. 4). A 1 ng/μL solution of Glu-fib was infused at 20 μL/min into a 0.5 mL/min carrier flow of 50/50 acetonitrile/water containing 0.01% formic acid.

FIG. 5(b) shows the Glu-fib mass spectrum that was obtained without inductive heating on a triple quadrupole MS that was operated in MS mode.

During the same experiment, a total inductive power (including the induction coil) of approximately 25 W was applied to the impactor and the Glu-fib mass spectral intensity was observed to increase significantly, as shown in FIG. 5(a). Here, inductive heating has increased the intensity of the protonated molecule ([M+2H]²⁺) by a factor of ×9.

Glu-fib is a relatively involatile analyte that does not exhibit high sensitivity in standard impactor spray sources but is clearly shown to benefit from additional heating of the impactor surface.

It should be noted that conventional heating via the desolvation gas heater 4 was used in both cases and inductive heating of the impactor may not replace the benefit of a hot stream of desolvation gas. This observation lends support to the hypothesis that the elevated impactor temperature improves the efficiency of droplet break-up but evaporation of these secondary droplets must still occur in the hot gas flow of the impactor wake.

Neuropeptide-Y (NPY) is another example of a relatively involatile/labile analyte that is difficult to ionize with high efficiency in a conventional impactor spray source. The effects of inductively heating the impactor target in an impactor spray source were characterized by infusing a 1 ng/μL solution of NPY at 40 μL/min into a 0.5 mL/min carrier flow of 50/50 acetonitrile/water containing 0.01% formic acid.

FIG. 6 compares the mass spectra obtained from NPY for (a) an unheated impactor and (b) an inductively heater impactor with a total inductive power of approximately 25 W. FIG. 6(b) shows that impactor heating produces a strong mass spectrum for ions with charge states of 3⁺ to 6⁺. In comparison, the unheated impactor (FIG. 6(a)) produces an NPY mass spectrum of weak ion intensity where the 6⁺ ion is approximately one sixth of the intensity of the same ion for a heated impactor.

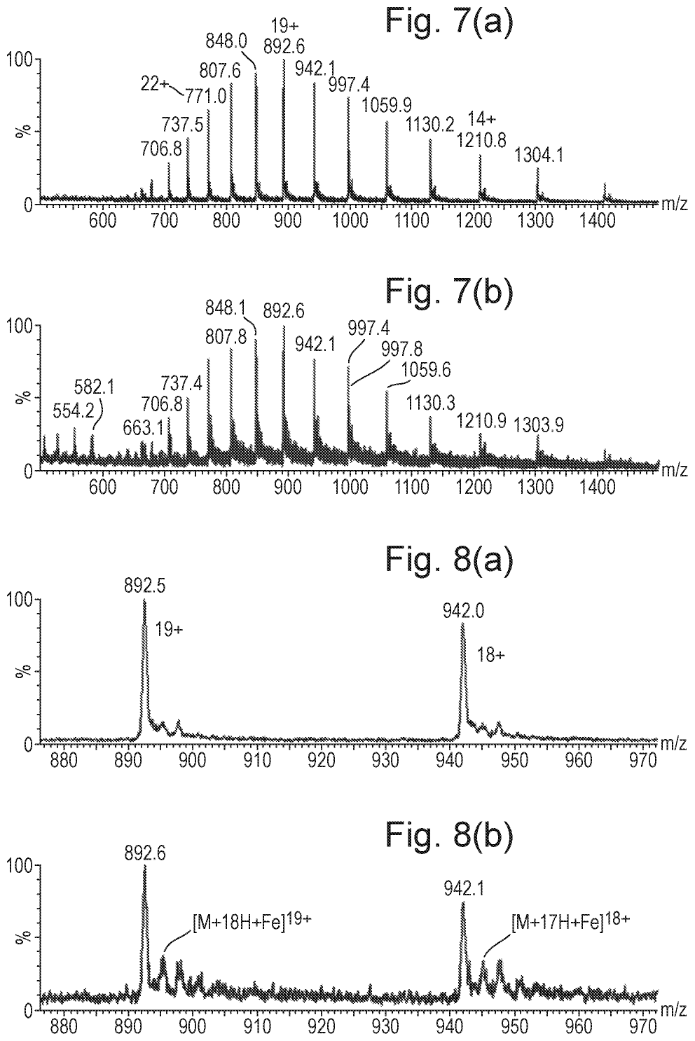

The effects of directly heating an impactor target were also evaluated for protein analytes. FIG. 7 shows the horse heart myoglobin (HHM) mass spectra obtained for (a) a heated impactor and (b) an unheated impactor for the infusion of a 1 ng/μL solution of HHM at 20 μL/min into a 0.5 mL/min carrier flow of 50/50 acetonitrile/water containing 0.01% formic acid.

A comparison of the figures reveals that impactor heating (27 W of total inductive power) leads to a four-fold increase in ion intensities. A closer inspection of the spectra reveals that the heated impactor exhibits “cleaner” mass spectral peaks with reduced metal ion adducting.

This is shown in the zoomed view of the same data in FIGS. 8 (a) and (b). The unheated impactor (FIG. 8(b)) shows strong peaks for what are believed to be Fe-adducts that are not prominent on the heated impactor spectrum (FIG. 8(a)). Since the impactor material in these experiments was mild steel, it is believed that the Fe-adducts are produced in electrochemical reactions as the droplets impact and directly contact the impactor surface. In the case of the inductively heated impactor, the Leidenfrost effect would protect the droplets from direct contact with the surface, thus eliminating or reducing the formation of unwanted Fe-adducts.

In the examples shown in FIGS. 5-8, enhanced ionization efficiency by additional heating at the impactor surface has been demonstrated for relatively involatile and thermally labile analytes. However, it should be noted that ion signal gains with direct impactor heating can also be observed with relatively volatile analytes such as, for example, acetaminophen, caffeine, sulphadimethoxine, and the like. Three to four-fold signal increases have been observed with these analytes for lower inductive powers of typically 10-18 W (data not shown).

In the Leidenfrost droplet impact model described above, it is postulated that smaller droplets are formed as a result of delayed break-up and greater thinning of the liquid film as the liquid layer expands radially. In the traditional electrospray model of gas-phase ion generation from charged droplets, it is known that the production of smaller droplets can lead to reduced metal ion adducts and reduced ion suppression effects where analyte ion signals are reduced by the presence of other analytes or contaminants which all compete for the available charge at the droplet surface.

If inductive (or any direct) heating of the impactor is generating smaller droplets at the impactor surface, then it may be possible to reduce ion suppression of an analyte in comparison to that observed with an unheated impactor.

To test this hypothesis, an analyte of interest was infused into an impactor spray source at a constant concentration and flow rate and its MS signal was monitored as the concentration of a suppressant (PEG-600) was gradually increased from zero.

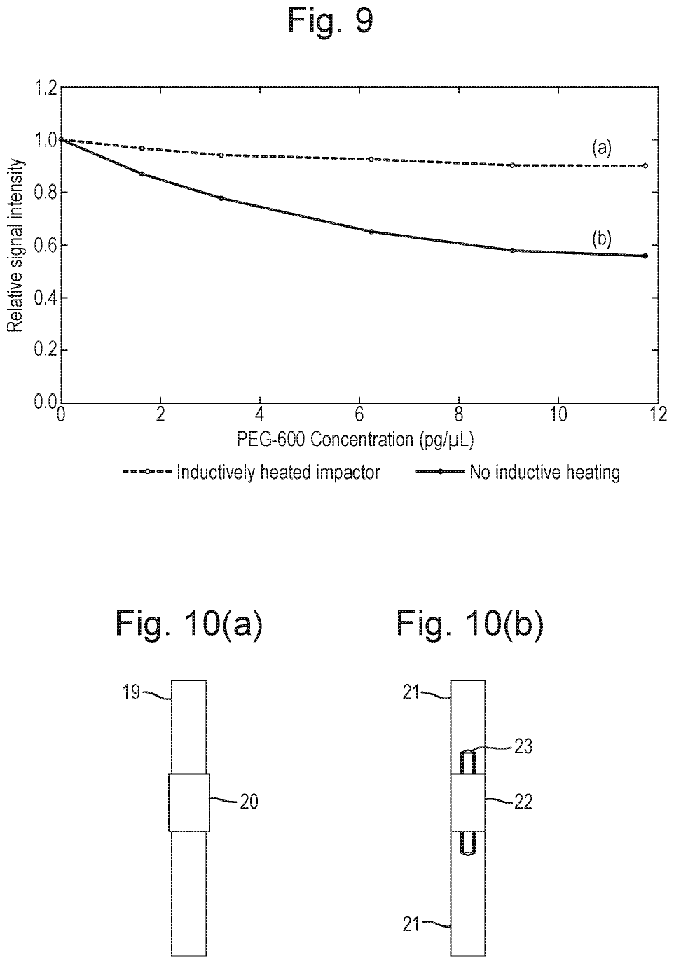

FIG. 9 shows the relative signal intensity obtained with (a) a heated impactor and (b) an unheated impactor for a fg/μL verapamil solution (70/30 water/acetonitrile with 0.01% formic acid) with increasing concentrations of PEG-600 from zero to approximately 12 pg/μL. The total flow rate was 0.6 mL/min.

If ion suppression did not occur under these conditions, it would be expected that the curves in FIG. 9 would be flat at a relative intensity of 1.0 for all values of PEG-600 concentration. However, as shown in the unheated impactor data FIG. 9(b), the verapamil signal is observed to fall significantly as the PEG-600 concentration is increased.

In contrast, heating the impactor (FIG. 9(a)) leads to a reduced reduction in ion signal (reduced ion suppression) which may indicate that the heating is promoting the formation of small droplets at the impactor. Reduced ion suppression was also observed with impactor heating for caffeine, sulphadimethoxine and hydroxyprogesterone (data not shown).

In the explanation of the principles of inductive heating described above, it was described how the greatest heating efficiency is obtained from ferrous (and/or ferritic) materials that exhibit magnetic hysteresis. Consequently, the impactor target described in the present embodiment may be in the form of a cylindrical, mild steel rod. Mild steel is not an ideal impactor material since it corrodes heavily and is known to promote the formation of Fe-adducts (FIG. 8) in the mass spectrum.

FIG. 10 shows two particular embodiments of an impactor target for an inductively heated impactor spray source which may be constructed partly from ferrous metal.

FIG. 10(a) shows a two-part impactor that may be constructed from a ferrous (and/or ferritic) rod 19 and a thin, cylindrical sleeve 20 that may be made from a non-corrosive, conducting material such as stainless steel or chromium, and the like. The sleeve 20 may be welded or shrink-fitted onto the ferrous rod 19.

In operation, the sleeve may be positioned in the gap of the induction coil such that the spray impact point (16 in FIG. 3(a)) lies on the sleeve section. The magnetic steel core 19 will efficiently heat in the magnetic field from the coil and transfer this heat to the “clean” sleeve.

FIG. 10(b) is an alternative three-part embodiment that works on the same principle as the two-part impactor. Here, a solid, cylindrical stainless steel section 22, that includes two threaded studs 23, may be connected to two ferrous (and/or ferritic), magnetic legs 21.

Thus, in various embodiments, the one or more first regions of the target may comprise a first electrically conductive, ferrous and/or ferritic (magnetic) material (such as mild steel), and the second region of the target may comprise a second different material (such as stainless steel or chromium). The second material may be more resistant to corrosion than the first material.

The target may comprise a rod comprising the first material surrounded by a sleeve comprising the second material, where the sleeve may be located in the second (inner) region of the target. Alternatively, the target may comprise first and second outer rods comprising the first material and a third inner rod comprising the second material, where the third rod may be located in the second (inner) region of the target. The first, second and third rods may be connected by appropriate fittings such as screw fittings.

It should also be noted that some materials, such as for example AISI 4140 stainless steel, exhibit both corrosion resistant and magnetic properties. As such, these ferritic materials, such as these stainless steel grades (for example, the 400 series), could also be employed in a simple, one-piece impactor design.

Although embodiments described above, for example as depicted in FIGS. 3 and 4, have a double induction coil design (where a gap is provided in the coil winding), other embodiments comprise a single coil design (where no such gap is provided in the coil winding). These embodiments can reliably operate at higher impactor voltages.

As depicted in FIG. 4, in embodiments described above, the coil 12 may be arranged between the ion inlet and the target 5. As shown in FIGS. 3 and 4, this arrangement can mean that the target 5 has to be offset from the centre of the coil 12. The close proximity of the double coil 12 to the inlet cone 8 can accordingly result in a small gap between the coil 12 and the high voltage (HV) impactor 5. This can in turn practically limit the impactor voltage, for example to around 2 kV, for example so as to avoid electrical breakdown in the medium between the high voltage (HV) impactor 5 and the coil 12.

Thus, although the design of FIGS. 3 and 4 is favourable in terms of heating efficiency, it may be less suited to the analysis of large biomolecules that can require high impactor voltages, which may for example be as high around 4 kV.

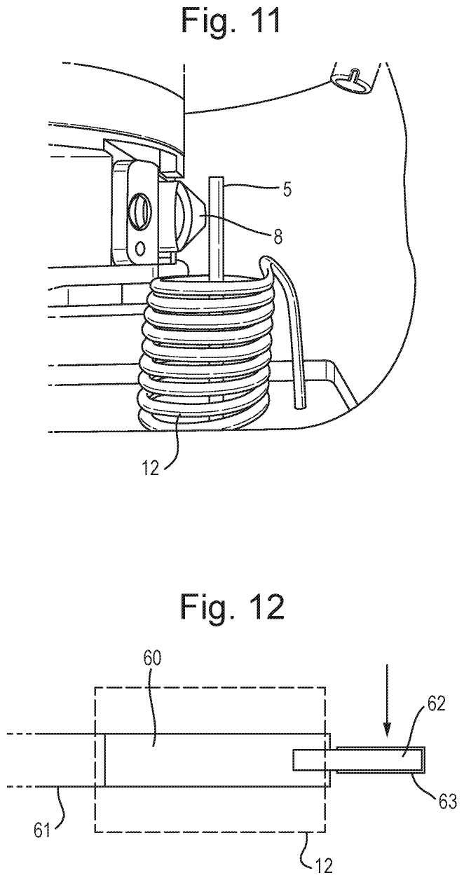

FIG. 11 shows a single coil design according to various embodiments, where the induction coil 12 may be retracted to a region within the ion source with no space restrictions. In particular, the coil 12 is moved to a position offset from the inlet orifice 8 in the third (z) direction. This design allows the high voltage (HV) impactor 5 to be located centrally with respect to the coil 12, which in turn increases the maximum operating voltage, for example to around 4 kV, without risking electrical breakdown in the medium between the target 5 and the coil 12.

Thus, the ion source may be configured such that a first region of the target is surrounded by the induction coil and such that a second region of the target is other than (is not) surrounded by the induction coil, where the spray of droplets may be arranged to impact upon the second region of the target.

As shown in FIG. 11, the second region may comprise an end region of the target (that is, a region at one end of the target in the third (z) direction), and the first region may comprise the other end region of the target (that is, a region at the other end of the target in the third (z) direction).

In these embodiments, since the magnetic field intensity falls rapidly in the third (z) (axial) direction from the end of the coil 12, the heating relies greatly on the thermal conductivity of the impactor material to transfer heat to the spray impact point.

However, the thermal conductivities (k) of ferritic materials can vary greatly. For example, iron and 1.5% carbon steel have k values of 94 and 36 Wm⁻¹K⁻¹, respectively. Furthermore, these materials may have low k values when compared to metals such as copper (k=413 Wm⁻¹K⁻¹) or aluminium (k=236 Wm⁻¹K⁻¹).

In order to obtain a balance between magnetic permeability and thermal conductivity, hybrid impactors can be fabricated that have improved characteristics when compared to any single impactor material.

FIG. 12 shows schematically a hybrid impactor design in accordance with various embodiments. Here, a ferritic section 60 of the impactor is held inside the induction coil by an insulator 61 and is efficiently heated by the high-frequency magnetic field. The heat from the ferritic section (typically mild steel) may be efficiently conducted to the spray impact point (indicated by the arrow) by a copper section 62 of the hybrid impactor.

Under normal impactor spray ionisation source operating conditions, such as the spraying of water and acetonitrile, a copper impactor surface will be subject to rapid oxidation and soot deposition. The latter may be due to a catalytic effect of copper on the pyrolysis of acetonitrile. In order to prevent degradation of the copper impactor surface which gives rise to low ionisation efficiency of analytes, the copper section 62 may be coated with an inert surface layer 63. This can be achieved, for example, by electrolytically plating the copper surface with a 0.5 to 5 micrometre layer of chromium.

Hybrid impactors as described above have been successfully implemented in inductively heated impactor spray sources for a wide range of analyte classes. These impactor types can be used with a double induction coil design (for example as described above), for example by adding an additional ferritic section 60 to the other end of the copper section 62 shown in FIG. 12.

As described above, the one or more first regions of the target may comprise a first electrically conductive, ferrous and/or ferritic (magnetic) material (such as mild steel), and the second region of the target may comprise a second different material (such as stainless steel or chromium) (where the second material may be more resistant to corrosion than the first material).

In various further embodiments, the target may comprise a third (electrically conductive) material (such as copper and/or aluminium) which may be arranged to connect the first material to the second material (that is, to connect the one or more first regions to the second region). The third material may have a higher thermal conductivity than the first and/or second material (and the second material may be more resistant to corrosion than the third material).

The target may comprise one or more first rods comprising the first material, and a second rod comprising the third material. The second rod may be surrounded by a sleeve such as a coating comprising the second material (where the sleeve (coating) may be located in the second region of the target). In these embodiments, each of the one or more first rods may be connected to the second rods by any appropriate fitting(s) such as a screw fitting, and the like.

Embodiments described above comprise an impactor spray source where the high voltage (HV) impactor target 5 is heated by an induction coil 12. These designs are particularly advantageous in that there is no contact between the high voltage (HV) on the impactor 5 and the induction heating circuit, which enables operation in the 0.1 to 5 kV range without fear of electrical breakdown (as described above).

Further embodiments will now be descried that may be as effective as the induction coil design in certain applications and can be modified to operate in the aforementioned voltage range.

According to these embodiments, a directly heated impactor may be produced by biasing the outer metal sheath of a cylindrical cartridge heater, for example to a voltage in the range 0.1 to 1 kV.

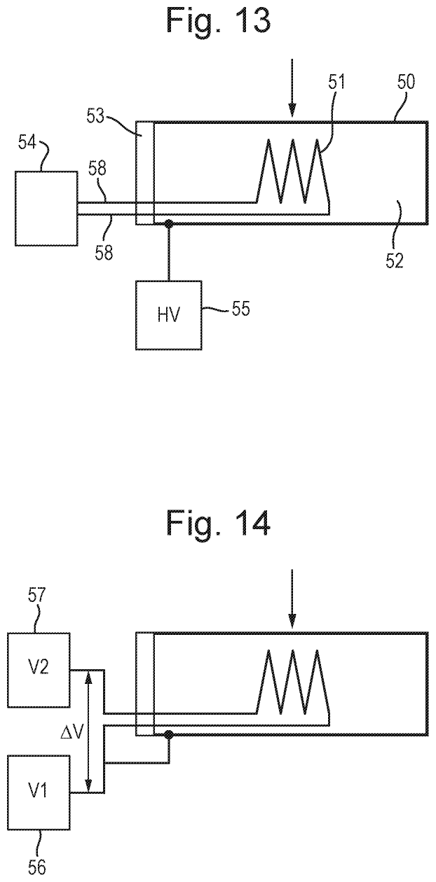

This arrangement is shown schematically in the cross-sectional view of the cylindrical cartridge heater of FIG. 13. As shown in FIG. 13, the cartridge heater comprises a metallic sheath 50 which may have a tubular (cylindrical) form.

A heating element 51 is arranged within the sheath 50, and is configured to heat the sheath 50. To do this, a power supply 54 may be configured to pass a current through the heating element 51 via leads 58, so as to cause Joule heating in the element 51. The element 51 may, for example, be heated by a 0-24V (0-100 W) power supply 54.

The space between the heating element 51 and the outer metal sheath 50 may be filled with a main insulator 52, such as compressed alumina or MgO powder. This may be hermetically sealed into the heater by a second insulator 53 that may also supports the element leads 58.

A high voltage (HV) power supply 55 may be configured to apply a voltage to the sheath 50, and the spray of droplets may be arranged to impact upon the sheath 50.

In FIG. 13, the arrow indicates the spray direction and the point of impact of droplets on the impactor surface. In embodiments, the heating element 51 only extends over a short length of the heater (≤8 mm), which has the effect of increasing the local power density in the vicinity of the spray impact point.

Thus, in embodiments, the target may comprise an electrically conductive tube such as a cylindrical sheath, and the spray of droplets may be arranged to impact upon the electrically conductive tube. The tube may have a length (in the third (z) direction).

The ion source may comprise a heater such as a resistive (resistance) heater, configured to heat the target (that is, configured to heat the tube). The heater may comprise a heating element arranged within (inside) the tube.

The tube may comprise a second region, for example an inner region of the target (that is, a central region of the target in the third (z) direction), and one or more first regions may comprise, for example two outer regions of the target (that is, two regions at either end of the target in the third (z) direction). The spray of droplets may be arranged to impact upon the second region of the tube.

The heating element may be arranged within the second region of the tube, and may not be (may other than be) arranged within the one or more first regions of the tube.

The ion source may comprise a first voltage source configured to apply a first voltage V₁ to the electrically conductive tube.

The heater may comprise a second voltage source configured to cause a current to pass through the heating element. To do this, as shown in FIG. 13, the second voltage source may be configured to apply a voltage ΔV between a first end of the heating element and a second end of the heating element.

In these embodiments, the sheath 50 may be biased in the range 0.1-1.0 kV by a high voltage (HV) power supply 55, without risking electrical breakdown in the medium between the element 51 and the sheath 50.

The embodiment depicted in FIG. 13 was experimentally observed to operate with high ionisation efficiency for relatively small molecules such as glu-fibrinopeptide (1570.57 Da). However, the maximum permissible impactor (sheath) voltage of 1 kV may not be adequate for the efficient ionisation of large proteins, such as monoclonal antibodies (mAb), which typically require impactor voltages of 3.5 kV or higher. In these embodiments, impactor voltages of greater than 1 kV may not be reliably useable since electrical breakdown can occur between the sheath and the resistively heated element or element leads.

FIG. 14 shows an alternative voltage biasing arrangement for the same hardware shown in FIG. 13, in accordance with various embodiments.

In this embodiment, one of the element leads is biased to a high voltage, V₂, from a high voltage (HV) power supply 57. The other lead and the outer sheath 50 are biased at a different high voltage, V₁, from a second high voltage (HV) power supply 56.

Thus, the first voltage source and a second voltage source may be configured to apply a voltage ΔV between the first end of the heating element and the second end of the heating element.

The first voltage source may be configured to apply the first voltage V₁ to the first end of the heating element (such that the first end of the heating element is maintained at substantially the same voltage as the electrically conductive tube), and the second voltage source may be configured to apply a second different voltage V₂ to the second end of the heating element, where |V2−V1|=ΔV.

In practice, the difference ΔV between V₁ and V₂ may be small and may typically be the range 0-24V for a typical element resistance of, for example, 6 Ohms.

In these embodiments, the power delivered to the heater element 51 is given by (ΔV)²/R, where R is the resistance of the element 51. Thus, to operate the impactor at +4 kV with 24 W of heating power, V₂ could be set to for example 4.012 kV and V₁ could be set to 4.000 kV for an element resistance of 6 Ω. In this example, the voltage difference ΔV is only 12V and is well within the insulation limit of the cartridge heater.

Various further embodiments relate to the desolvation heater of an atmospheric pressure ionisation (API) ion source. Such heaters may be present in impactor ion sources such as the impactor ion source described above (namely desolvation heater 4), and may also be present in other types of ion source such as electrospray ionisation (ESI) ion sources. Thus, in various particular embodiments, the ion source comprises an electrospray ionisation (ESI) ion source.

In these embodiments, the (impactor or ESI) ion source may comprise a sprayer configured to produce the spray of droplets, and an inductive heater may be configured to heat a flow of gas so as to heat the spray of droplets via the heated flow of gas. The heated flow of gas may be provided to the (droplet) exit of the sprayer.

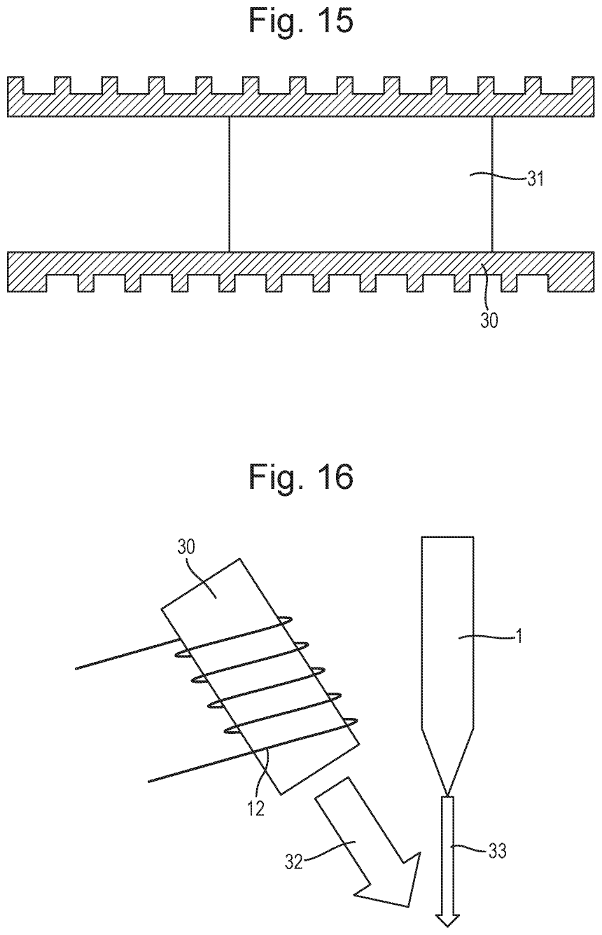

As shown in FIGS. 15 and 16, the heater may comprise a tube 30 such as a shroud, and the heater may be configured to heat a flow of gas within the tube (shroud) 30 so as to produce the heated flow of gas 32.

The (gas) outlet of the tube (shroud) 30 may be configured so that the heated gas 32 is provided to the outlet of the sprayer 1. The sprayer may be configured such that the heated gas emitted from the heated gas outlet causes desolvation of the droplets 33 emitted from the sprayer.

The heated (desolvation) gas may be emitted from the heated gas outlet with any suitable flow rate such as (i)<100 L/hr; (ii) 100-200 L/hr; (iii) 200-300 L/hr; (iv) 300-400 L/hr; (v) 400-500 L/hr; (vi) 500-600 L/hr; (vii) 600-700 L/hr; (viii) 700-800 L/hr; or (viii)>800 L/hr.

The (desolvation) gas may be heated to a temperature of (i)>100° C.; (ii)>150° C.; (iii)>190° C.; (iv)>200° C.; (v)>250° C.; (vi)>300° C.; (vii)>400° C.; or (viii)>500° C.

In various particular embodiments, the tube (shroud) 30 may be made from an electrically insulating material. The tube (shroud) 30 material may also be thermally insulating. The inductive heater may comprise an electrically conductive, ferrous and/or ferritic (magnetic) material 31 surrounded by (or adjacent to) an induction coil 12. The electrically conductive, ferrous and/or ferritic (magnetic) material 31 may be located within the tube 30, and the induction coil 12 may surround (or may be arranged adjacent to) the tube 30.

Application of an AC voltage to the induction coil may cause heating of the conductive, ferrous and/or ferritic (magnetic) material 31 within the tube (shroud) 30, which in turn may cause heating of the gas flow through the tube (shroud) 30. Thus, the ion source may comprise a voltage and/or current source 13 configured to pass an AC current through the induction coil.

In these embodiments, the conductive, ferrous and/or ferritic (magnetic) material 31 may have a relatively large surface area, so as to ensure efficient heat transfer from the conductive, ferrous and/or ferritic (magnetic) material 31 to the gas.

The conductive, ferrous and/or ferritic (magnetic) material 31 may fill a relatively large proportion of the cross sectional area of the tube 30 through which the gas flows. Thus, the ratio of the cross sectional area of the conductive, ferrous and/or ferritic (magnetic) material 31 to the cross sectional area of the tube 30 (through which gas flows) may be: (i)≥0.5; (ii)≥0.6; (iii)≥0.7; (iv)≥0.8; and/or (v)≥0.9. The conductive, ferrous and/or ferritic (magnetic) material 31 may also fill a relatively large proportion of the length of the tube 30 through which the gas flows. Thus, the ratio of the length of the conductive, ferrous and/or ferritic (magnetic) material 31 to the length of the tube 30 (through which gas flows) may be: (i)≥0.5; (ii)≥0.6; (iii)≥0.7; (iv)≥0.8; and/or (v)≥0.9.

The conductive, ferrous and/or ferritic (magnetic) material 31 may be formed from any suitable metallic material with a relatively large surface area. Suitable materials for the conductive, ferrous and/or ferritic (magnetic) material 31 include, for example, materials formed from metallic filaments such as metallic wool such as wire (steel) wool, porous materials such as sintered parts, and the like.

As described above, the Applicant has found that this arrangement increases the heating efficiency compared to conventional heating arrangements due to increased heat transfer at the high surface area of the wire wool, the extension of the heating zone to the exit of the shroud, and greatly reduced conductive and radiative losses from the insulating shroud. Furthermore, the non-conductive shroud can be closely coupled to the ESI tip without fear of electrical discharge.

In various further embodiments, the ion source may be configured such that at least some of the (desolvation) gas contacts the coil 12 before the (desolvation) gas is passed through the tube 30. As the coil 12 will itself (in operation) have a raised temperature (i.e. greater than the ambient temperature), causing the gas to contact the coil 12 prior to it entering the tube 30 will have the effect of pre-heating the gas, cooling the coil 12, and thereby reducing the power management requirements of the induction circuit.

In these embodiments, the ion source may be configured in any suitable manner such that at least some of the gas contacts the coil 12 before the gas is passed through the tube 30. For example, the ion source may be configured such that the (desolvation) gas flows over at least part of (an external surface of) the coil 12 before the (desolvation) gas is passed through the tube 30.

In various particular embodiments, the ion source is configured such that (desolvation) gas flows through a hollow region of the coil 12 before the (desolvation) gas is passed through the tube 30, i.e. such that the (desolvation) gas flows through an internal region of the coil 12 before the (desolvation) gas is passed through the tube 30.

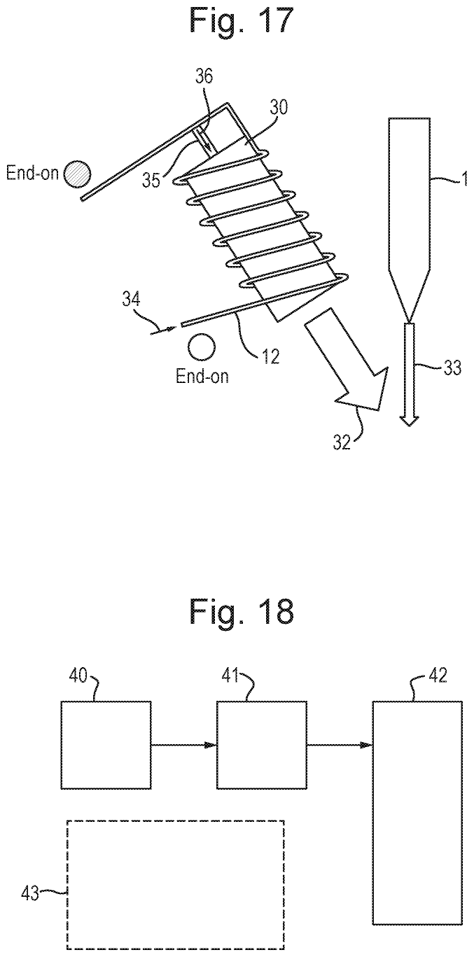

FIG. 17 shows one such embodiment, in which the induction coil 12 is hollow. The desolvation gas may be routed through the hollow region of the induction coil 12 prior to it entering the tube 30 (that may be filled with ferritic wire wool 31, e.g. as described above). In other words, the coil 12 may be formed using a tube, and the gas may be passed through the coil tube.

As shown in FIG. 17, a first inlet end of the coil 12 may be open-ended, and a second end of the coil 12 may be closed or blocked. The coil 12 may be formed from any suitable material as described herein, such as e.g. copper. “Cold” or ambient temperature gas 34 may be passed into the inlet end of the coil 12, and may be heated due to contact with the inside of the coil 12. The coil 12 may include a junction such as a tee 35 configured such that once the gas has passed though the coil 12, it is diverted into the tube 30. Pre-heated gas 36 exiting the coil 12 may then be heated as it passes through the tube 30 in the manner described above with reference to FIGS. 15 and 16.

Using the coil 12 itself as a gas conduit can beneficially pre-heat the gas, cool the coil 12, and thereby reduce the power management requirements of the induction circuit (i.e. because the gas is pre-heated).

The ion source may be for and/or may be part of an analytical instrument such as a mass and/or ion mobility spectrometer.

FIG. 18 shows schematically an analytical instrument such as a mass and/or ion mobility spectrometer in accordance with various embodiments. As shown in FIG. 18, the analytical instrument comprises the ion source 40 (as described above), one or more functional components 41 that are arranged downstream from the ion source 40, and an analyser 42 that is arranged downstream from the ion source 40 and from the one or more functional components 41.

As illustrated by FIG. 18 the analytical instrument may be configured such that ions can be provided by (sent from) the ion source 40 to the analyser 42 via the one or more functional components 41.

The ion source 40 may be configured to generate ions, for example by ionising an analyte (as described above). The analyser 42 may be configured to analyse ions, so as to determine (measure) one or more of their physico chemical properties, such as their mass to charge ratio, time of flight, (ion mobility) drift time and/or collision cross section (CCS).

The analyser 42 may comprise a mass analyser (that is configured to determine the mass to charge ratio or time of flight of ions) and/or an ion mobility analyser (that is configured to determine the ion mobility drift time or collision cross section (CCS) of ions).

Where the analyser 42 comprises a mass analyser, the mass analyser may comprise any suitable mass analyser such as a mass analyser selected from the group consisting of: (i) a quadrupole mass analyser; (ii) a 2D or linear quadrupole mass analyser; (iii) a Paul or 3D quadrupole mass analyser; (iv) a Penning trap mass analyser; (v) an ion trap mass analyser; (vi) a magnetic sector mass analyser; (vii) Ion Cyclotron Resonance (“ICR”) mass analyser; (viii) a Fourier Transform Ion Cyclotron Resonance (“FTICR”) mass analyser; (ix) an electrostatic mass analyser arranged to generate an electrostatic field having a quadro-logarithmic potential distribution; (x) a Fourier Transform electrostatic mass analyser; (xi) a Fourier Transform mass analyser; (xii) a Time of Flight mass analyser; (xiii) an orthogonal acceleration Time of Flight mass analyser; and (xiv) a linear acceleration Time of Flight mass analyser.

The one or more functional components 41 may comprise any suitable such components, devices and functional elements of an analytical instrument (mass and/or ion mobility spectrometer).

For example, in various embodiments, the one or more functional components 41 comprise one or more ion guides, one or more ion traps, and/or one or more mass filters, for example which may be selected from the group consisting of: (i) a quadrupole mass filter; (ii) a 2D or linear quadrupole ion trap; (iii) a Paul or 3D quadrupole ion trap; (iv) a Penning ion trap; (v) an ion trap; (vi) a magnetic sector mass filter; (vii) a Time of Flight mass filter; and (viii) a Wien filter.

The one or more functional components 41 may comprise an activation, collision, fragmentation or reaction device configured to activate, fragment or react ions.

The one or more functional components 41 may comprise an ion mobility separator configured to separate ions according to their ion mobility. The ion mobility separator may comprise a linear ion mobility separator, or a closed loop (cyclic) ion mobility separator.

The analytical instrument may be operated in various modes of operation including a mass spectrometry (“MS”) mode of operation; a tandem mass spectrometry (“MS/MS”) mode of operation; a mode of operation in which parent or precursor ions are alternatively fragmented or reacted so as to produce fragment or product ions, and not fragmented or reacted or fragmented or reacted to a lesser degree; a Multiple Reaction Monitoring (“MRM”) mode of operation; a Data Dependent Analysis (“DDA”) mode of operation; a Data Independent Analysis (“DIA”) mode of operation; a Quantification mode of operation; or an Ion Mobility Spectrometry (“IMS”) mode of operation.

It should be noted that FIG. 18 is merely schematic, and that the analytical instrument may (and in various embodiments does) include other components, devices and functional elements to those shown in FIG. 18.

As shown in FIG. 18, the analytical instrument may comprise a control system 43, that may be configured to control the operation of the analytical instrument, for example in the manner of the various embodiments described herein. The control system may comprise suitable control circuitry that is configured to cause the instrument to operate in the manner of the various embodiments described herein. The control system may comprise suitable processing circuitry configured to perform any one or more or all of the necessary processing and/or post-processing operations in respect of the various embodiments described herein. In various embodiments, the control system may comprise a suitable computing device (computer), a microprocessor system, a programmable FPGA (field programmable gate array), and the like.

It will be appreciated from the above that various embodiments provide an ion source with improved sensitivity.

As descried above, conventional impactor ionisation ion source sensitivity can be impaired, for example for involatile/labile analytes, due to inadequate impactor surface temperature. Conventional ESI sensitivity can be impaired by inadequate desolvation gas temperature due to inefficient heating and excessive losses in a conventional flow-over-element heater design.

The use of high-efficiency inductive heating in these ions sources provides higher impactor target and gas temperatures. The arrangement uses decoupled power, so that there is no need to isolate high voltages. This in turn means that critical heated parts can be simplified and can be made as consumables.

Although the present invention has been described with reference to preferred embodiments, it will be understood by those skilled in the art that various changes in form and detail may be made without departing from the scope of the invention as set forth in the accompanying claims.

1. An ion source comprising:
a sprayer configured to produce a spray of droplets;
a target, wherein the spray of droplets is arranged to impact upon the target; and
an inductive heater configured to heat the target.

2. The ion source of claim 1, further comprising a voltage source configured to apply a voltage to the target.

3. The ion source of claim 1, wherein the target comprises an electrically conductive, ferrous and/or ferritic material, and wherein the heater comprises an induction coil that is adjacent to and/or at least partially surrounds the target.

4. The ion source of claim 3, further comprising a voltage and/or current source configured to pass an AC current through the induction coil.

5. The ion source of claim 3, wherein:
the ion source is configured such that one or more first regions of the target are surrounded by the induction coil and such that a second region of the target is other than surrounded by the induction coil; and
the spray of droplets is arranged to impact upon the second region of the target.

6. The ion source of claim 5, wherein the second region comprises an end region of the target, and the one or more first regions comprises the other end region of the target.

7. The ion source of claim 5, wherein the one or more first regions comprise a first electrically conductive, ferrous and/or ferritic material, wherein the second region comprises a second different material, and wherein the second material is more resistant to corrosion than the first material.

8. The ion source of claim 7, wherein the target comprises a third different material configured to connect the first material to the second material, wherein the third different material has a higher thermal conductivity than the first material and/or the second material.

9. An ion source comprising:
a sprayer configured to produce a spray of droplets;
a target comprising an electrically conductive tube, wherein the spray of droplets is arranged to impact upon the electrically conductive tube;
a heater configured to heat the target, wherein the heater comprises a heating element arranged within the tube; and
a first voltage source configured to apply a first voltage to the electrically conductive tube.

10. The ion source of claim 9, wherein the target comprises one or more first regions and a second region, wherein the spray of droplets is arranged to impact upon the second region of the target, and wherein the heating element is arranged within the second region of the target.

11. The ion source of claim 9, wherein the heater comprises a second voltage source configured to cause a current to pass through the heating element, and wherein the second voltage source is configured to apply a voltage ΔV between a first end of the heating element and a second end of the heating element.

12. The ion source of claim 9, wherein the heater comprises a second voltage source configured to cause a current to pass through the heating element, wherein the first voltage source and the second voltage source are configured to apply a voltage ΔV between the first end of the heating element and the second end of the heating element, and wherein the first voltage source is configured to apply the first voltage to the first end of the heating element.

13. The ion source of claim 9, wherein the spray of droplets is arranged to impact upon the target so as to ionise the droplets.

14. The ion source of claim 9, further comprising an inductive heater configured to heat a flow of gas, wherein the heated flow of gas is arranged to heat the spray of droplets.

15. An ion source comprising:
a sprayer configured to produce a spray of droplets; and
an inductive heater configured to heat a flow of gas, wherein the heated flow of gas is arranged to heat the spray of droplets.

16. The ion source of claim 15, wherein the ion source is configured such that the heated flow of gas is provided to an exit of the sprayer.

17. The ion source of claim 15, wherein:
the heater comprises a tube, and wherein the heater is configured to heat the flow of gas within the tube so as to produce the heated flow of gas;
wherein the tube is made from an electrically insulating material; and
wherein the inductive heater comprises an electrically conductive, ferrous and/or ferritic material and an induction coil, and wherein the electrically conductive, ferrous and/or ferritic material is located within the tube.

18. The ion source of claim 17, wherein the conductive, ferrous and/or ferritic material comprises a material formed from metallic filaments, metallic wool, a porous material, a sintered part, or another metallic material having a relatively large surface area.

19. The ion source of claim 17, wherein the ion source is configured such that the flow of gas contacts the induction coil before entering the tube.

20. A method of ionisation comprising using the ion source of claim 17 to produce ions.
